(19) United States
(12) Patent Application Publication
(10) Pub. No.: US 2003/0081003 A1
(43) Pub. Date: May 1, 2003

(54) System and method to facilitate analysis and removal of errors from an application

(76) Inventors: Ali Kutay, Palo Alto, CA (US); Cihan Akin, Redwood City, CA (US); Erhan Akin, Foster City, CA (US); Hakan Akin, San Mateo, CA (US); Eliahu Albek, San Francisco, CA (US); John Gilbert, Belmont, CA (US); Paul Stremel, Moss Beach, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 10/082,427

(22) Filed: Feb. 22, 2002

Related U.S. Application Data
(60) Provisional application No. 60/270,837, filed on Feb. 23, 2001.

(51) Int. Cl. G09G 5/00

(52) U.S. Cl. 345/762

(57) ABSTRACT

A system and method to facilitate analysis and removal of errors from an application are described. A first user interface area is presented to display an application layout of the application, the application layout including multiple application icons and one or more connections that connect the application icons, each application icon corresponding to an application component of the application. A second user interface area is presented to enable a user to execute the application and to run a debug session in order to visually remove the errors from each application component of the application displayed within the first user interface area.

### RELATED APPLICATIONS

The present application claims the benefit of U.S. Provisional Patent Application Serial No. 60/270,837, filed on Feb. 23, 2001 and entitled “SYSTEM AND METHOD FOR ACCESSING, ORGANIZING, PRESENTING, AND VIEWING DATA.”

### FIELD OF THE INVENTION

The present invention relates generally to data representation and, more particularly, to a system and method to facilitate analysis and removal of errors from an application.

### BACKGROUND

The movement toward development, deployment, and maintenance of Internet, and especially World Wide Web (Web), based applications, such as, for example, J2EE-compliant enterprise applications, represents one of the most significant recent trends in the corporate Information Technology (IT) environment. However, the deployment and maintenance of such applications require tools and technology that are complex and skill sets that are rare.

Typically, web applications have a different lifecycle than most other applications. Most applications are delivered when finished, but a web application continues to change, as new market requirements are understood. As a result, projects are fraught with certain risk, due to the myriad of moving pieces having no methodology to hold them together.

Under technological pressure and facing a lack of resources, IT organizations decide to outsource the development of web applications. However, as the applications evolve, such reliance on third parties for development and maintenance may slow down progress, as each new third party learns what the previous group has accomplished, thereby impeding the necessary quick response time.

Furthermore, the process of analysis and removal of errors from the developed application running on a server, also known as the process of debugging the application, can be a challenging experience because the application is typically executing from a browser outside of the development platform. In addition, any debug events that are logged during the execution are typically not available to the user in the design environment, thereby making application debugging a daunting task.

Therefore, what is needed is a single, integrated, development and runtime platform for web applications that streamlines the development, deployment, monitoring, and management of such applications, while improving productivity and quality, and, at the same time, significantly reducing associated costs. Further, what is needed is a debugging method that allows a user to remove errors from a web application, while having access to the debug events during the execution of the application.

### SUMMARY

A system and method to facilitate analysis and removal of errors from an application are described. A first user interface area is presented to display an application layout of the application, the application layout including multiple application icons and one or more connections that connect the application icons, each application icon corresponding to an application component of the application. A second user interface area is presented to enable a user to execute the application and to run a debug session in order to visually remove the errors from each application component of the application displayed within the first user interface area.

Other features and advantages of the present invention will be apparent from the accompanying drawings and from the detailed description that follows.

### BRIEF DESCRIPTION OF THE DRAWINGS

The present invention is illustrated by way of example and not limitation in the figures of the accompanying drawings, in which like references indicate similar elements and in which:

FIG. 1 is a block diagram of a conventional network architecture.

FIG. 2 is a block diagram of one embodiment of the network including a system to facilitate analysis and removal of errors from an application.

FIG. 3 is a block diagram of a conventional computer system.

FIG. 4A is a block diagram of an application architecture.

FIG. 4B is a block diagram of one embodiment for a user interface module.

FIG. 5 is a block diagram of one embodiment for a process within the application.

FIG. 6 illustrates one embodiment of a user interface to define the application within the system.

FIG. 7 illustrates one embodiment of an Application Manager window area within the user interface.

FIG. 8 illustrates one embodiment of a first user interface area to display an application layout of a selected application.

FIG. 9 illustrates an alternate embodiment of a first user interface area to display an application layout of a selected application.

FIG. 10 illustrates an interactive window area within the first user interface area to display a scaled rendering of the application layout.

FIG. 11 illustrates a block diagram of an application layout displayed within the first user interface area.

FIG. 12 illustrates one embodiment of a method to facilitate analysis and removal of errors from an application.

FIG. 13 illustrates one embodiment of an execution of a debug session within the method to facilitate analysis and removal of errors from an application.

FIG. 14 illustrates an exemplary second user interface area to facilitate analysis and removal of errors from an application.

FIG. 15 illustrates the second user interface area and an exemplary browser window area displayed upon launch of a browser.

FIG. 16 illustrates the exemplary first and second user interface areas.

FIG. 17 illustrates an exemplary third user interface area to display a process layout of a process within the application.

FIG. 18 illustrates the first and second user interface areas and the browser window area at the conclusion of an error-free debug session.

FIG. 19 illustrates the first and second user interface areas and the browser window area at the conclusion of a debug session resulting in errors.

FIG. 20 illustrates a process editor window area within the user interface to display a process within the application.

FIG. 21 illustrates a process test interface area to test and debug the process.

FIG. 22 illustrates the process test interface area to display results of the execution of the process.

FIG. 23 illustrates an exemplary process debug interface area to debug the process.

FIG. 24 illustrates the process editor window area to display the process and the process debug interface area to facilitate display of a debug session of the process.

FIG. 25 illustrates the process editor window area to display an inline process and the process debug interface area to facilitate display of a debug session of the inline process.

### DETAILED DESCRIPTION

According to embodiments described herein, a system and method to facilitate analysis and removal of errors from an application are described. A first user interface area is presented to display an application layout of the application, the application layout including multiple application icons and one or more connections that connect the application icons, each application icon corresponding to an application component of the application. A second user interface area is presented to enable a user to execute the application and to run a debug session in order to visually remove the errors from each application component of the application displayed within the first user interface area.

In the following detailed description of embodiments of the invention, reference is made to the accompanying drawings in which like references indicate similar elements, and in which are shown by way of illustration specific embodiments in which the invention may be practiced. These embodiments are described in sufficient detail to enable those skilled in the art to practice the invention, and it is to be understood that other embodiments may be utilized and that logical, mechanical, electrical, functional, and other changes may be made without departing from the scope of the present invention. The following detailed description is, therefore, not to be taken in a limiting sense, and the scope of the present invention is defined only by the appended claims.

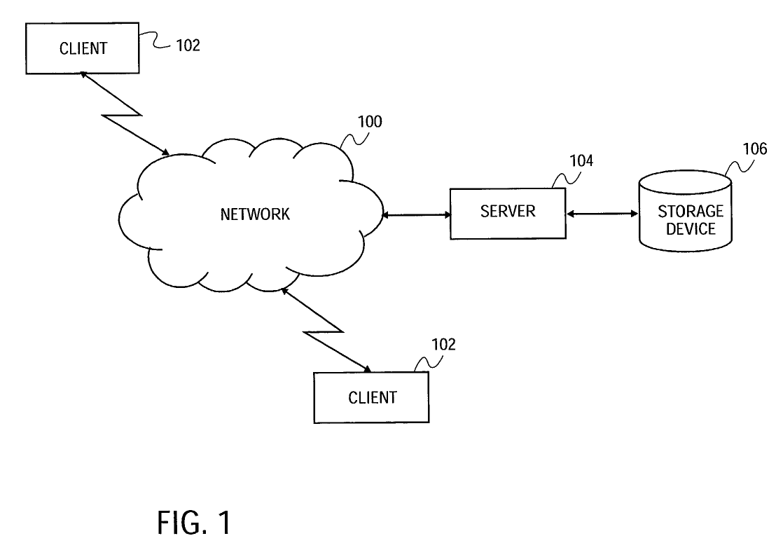

FIG. 1 is a block diagram of a conventional network architecture. Referring to FIG. 1, the block diagram illustrates the network environment in which the present invention operates. In this conventional network architecture, a server computer system 104 is coupled to a network 100, for example a wide-area network (WAN). Wide-area network 100 includes the Internet, specifically the World Wide Web, or other proprietary networks, such as America Online™, CompuServe™, Microsoft Network™, and/or Prodigy™, each of which are well known to those of ordinary skill in the art. Wide-area network 100 may also include conventional network backbones, long-haul telephone lines, Internet service providers, various levels of network routers, and other conventional means for routing data between computers. Using conventional network protocols, server 104 may communicate through wide-area network 100 to a plurality of client computer systems 102, possibly connected through wide-area network 100 in various ways or directly connected to server 104. For example, as shown in FIG. 1, clients 102 are connected directly to wide-area network 100 through direct or dial-up telephone or other network transmission line. Alternatively, clients 102 may be connected to wide-area network 100 through a conventional modem pool (not shown).

Using one of a variety of network connection devices, server computer 104 can also communicate directly with a client 102. In a particular implementation of this network configuration, a server computer 104 may operate as a web server if the World Wide Web (Web) portion of the Internet is used as wide-area network 100. Using the Hyper Text Transfer Protocol (HTTP) and the Hyper Text Markup Language (HTML) across a network, web server 104 may communicate across the Web with client 102. In this configuration, client 102 uses a client application program known as a web browser, such as the Netscape Navigator™ browser, published by America Online™, the Internet Explorer™ browser, published by Microsoft Corporation of Redmond, Wash., the user interface of America Online™, or the web browser or HTML translator of any other supplier. Using such conventional browsers and the Web, client 102 may access graphical and textual data or video, audio, or tactile data provided by server 104. Conventional means exist by which client 102 may supply information to web server 104 through the network 100 and the web server 104 may return processed data to client 102.

Server 104 is further connected to storage device 106. Storage device 106 may be any suitable storage medium, for example read only memory (ROM), random access memory (RAM), EPROMs, EEPROMs, magneto-optical discs, or any other type of medium suitable for storing electronic data.

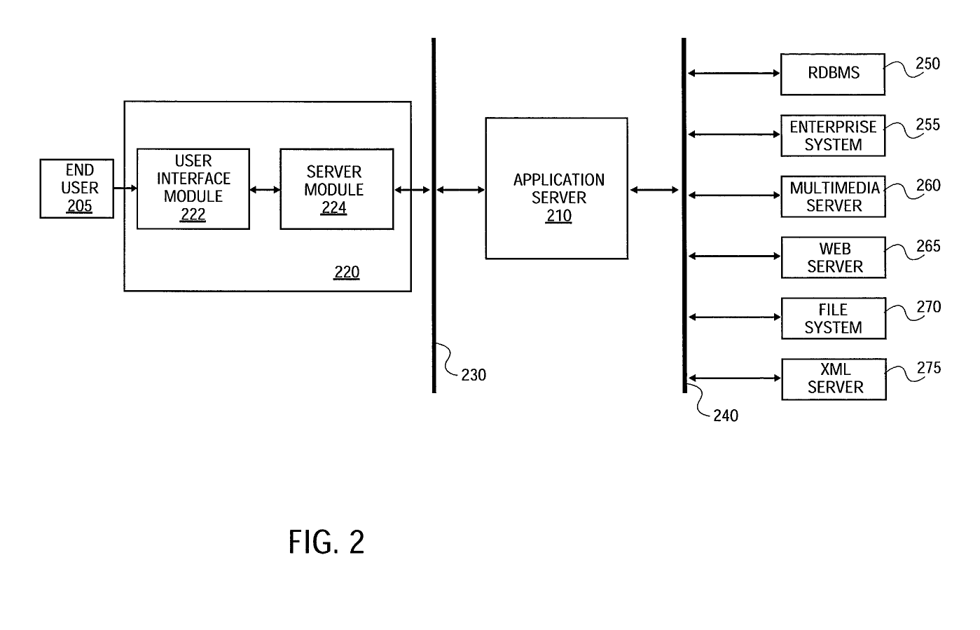

FIG. 2 is a block diagram of one embodiment for the network including a system to facilitate analysis and removal of errors from an application. As illustrated in FIG. 2, in one embodiment, application server 210 is connected to one or more clients 220 via bus 230. Alternatively, server 210 may be connected to clients 220 via WAN 100. Client 220 further includes a user interface module 222 coupled to a server module 224. In another alternate embodiment, several application servers 210 are connected to clients 220 via bus 230 or via WAN 100.

End users, for example end user 205, interact with client 220 via user interface module 222. In one embodiment, end user 205 interacts with the user interface module 222 within client 220 through a browser (not shown) and WAN 100. Alternatively, end user 205 may interact with user interface module 222 directly or through any connection of a number of known types of connections.

In one embodiment, server 210 is also connected to several data sources via bus 240. Alternatively, server 210 may be connected to the data sources via WAN 100. The data sources may include for example a relational database module (RDBMS) 250, an enterprise system 255, a multimedia server 260, a web server 265, a file system 270, and/or an XML server 275. Alternatively, server 210 may be connected to any of a variety of additional data sources. In one embodiment, the data sources reside in storage device 106. Alternatively, the data sources may reside on disparate storage mediums.

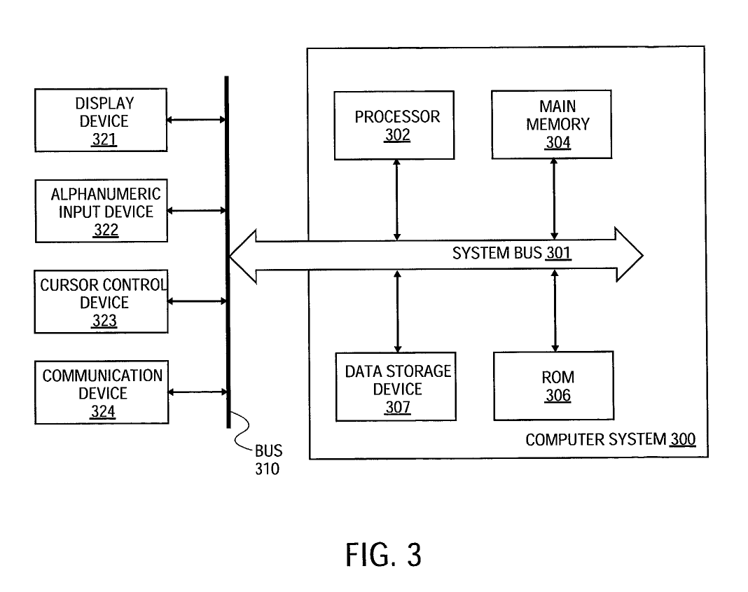

Having briefly described one embodiment of the network environment in which the present invention operates, FIG. 3 shows an exemplary block diagram of a conventional computer system 300 illustrating an exemplary client 102 or server 104 computer system in which the features of the present invention may be implemented.

Computer system 300 includes a system bus 301, or other communications module similar to the system bus, for communicating information, and a processing module, such as processor 302, coupled to bus 301 for processing information. Computer system 300 further includes a main memory 304, such as a random access memory (RAM) or other dynamic storage device, coupled to bus 301, for storing information and instructions to be executed by processor 302. Main memory 304 may also be used for storing temporary variables or other intermediate information during execution of instructions by processor 302.

Computer system 300 also comprises a read only memory (ROM) 306, and/or other similar static storage device, coupled to bus 301, for storing static information and instructions for processor 302.

In one embodiment, an optional data storage device 307, such as a magnetic disk or optical disk, and its corresponding drive, may also be coupled to computer system 300 for storing information and instructions. System bus 301 is coupled to an external bus 310, which connects computer system 300 to other devices. In one embodiment, computer system 300 can be coupled via bus 310 to a display device 321, such as a cathode ray tube (CRT) or a liquid crystal display (LCD), for displaying information to a computer user. For example, graphical or textual information may be presented to the user on display device 321. Typically, an alphanumeric input device 322, such as a keyboard including alphanumeric and other keys, is coupled to bus 310 for communicating information and/or command selections to processor 302. Another type of user input device is cursor control device 323, such as a conventional mouse, touch mouse, trackball, or other type of cursor direction keys, for communicating direction information and command selection to processor 302 and for controlling cursor movement on display 321. In one embodiment, computer system 300 may optionally include video, camera, speakers, sound card, and many other similar conventional options.

Alternatively, the client 102 can be implemented as a network computer or thin client device, such as the WebTV Networks™ Internet terminal or the Oracle™ NC. Client 102 may also be a laptop or palm-top computing device, such as the Palm Pilot™. Such a network computer or thin client device does not necessarily include all of the devices and features of the above-described exemplary computer system. However, the functionality of the present invention may nevertheless be implemented with such devices.

A communication device 324 is also coupled to bus 310 for accessing remote computers or servers, such as server 104, or other servers via the Internet, for example. The communication device 324 may include a modem, a network interface card, or other well-known interface devices, such as those used for interfacing with Ethernet, Token-ring, or other types of networks. In any event, in this manner, the computer system 300 may be coupled to a number of servers 104 via a conventional network infrastructure such as the infrastructure illustrated in FIG. 1 and described above.

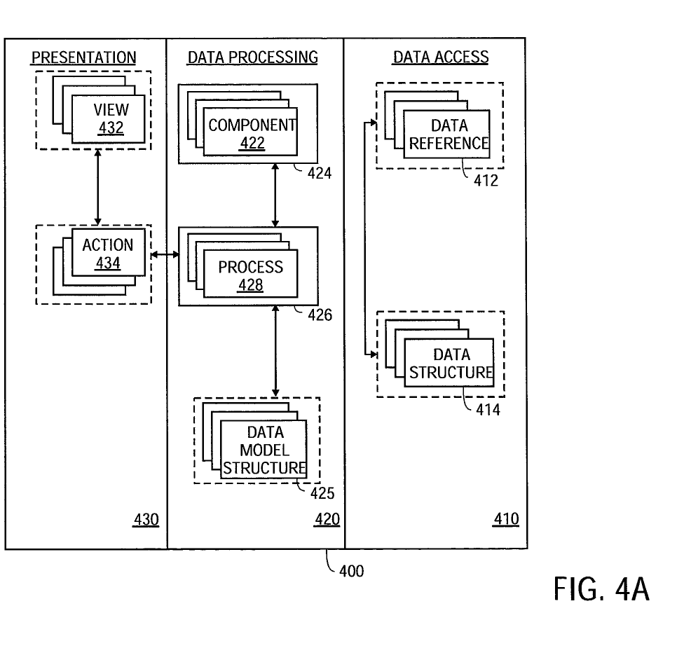

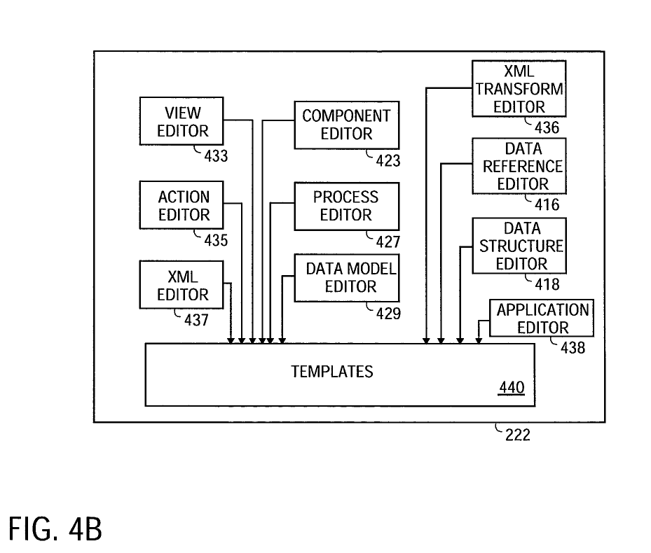

FIG. 4A is a block diagram of an application architecture. As illustrated in FIG. 4A, in one embodiment, application 400 includes a data access layer 410 configured to access and extract data from one or more data sources 250-275, shown in FIG. 2, a data processing layer 420 coupled to the data access layer 410 and configured to process and manipulate data, and a presentation layer 430 coupled to the data processing layer 420 and configured to interact with the processed data and to present one or more views of the processed data to an end user 205.

The data access layer 410 includes multiple data reference structures 412 which define ways to locate and connect to data within the data sources 250-275, and multiple data structures 414, which are typically based on the data reference structures 412.

In one embodiment, each data reference structure 412 is an object that specifies the source connection information to data. For example, one data reference structure 412 may be defined to access a relational database located locally or on a remote server, such as RDBMS 250 shown in FIG. 2. Alternatively, other data reference structures 412 may be a flat file, a web file, or an XML document, designed to connect to file system 270, web server 265, or XML server 275, respectively. A user 205 may define one or more data reference structures 412 using a data reference editor residing within the user interface module 222.

In one embodiment, each data structure 414 is an object, which refers to one or more data reference structures 412 and which includes metadata that defines the data to be accessed, specifies a set of operations to be performed on the data, and defines logic to be applied when data is retrieved from the accessed data source. Alternatively, some data structures 414, labeled abstract data structures, may be created without a reference to a data reference structure. In one embodiment, the set of operations specified are SQL operations and include operations to query, insert, update, and delete data.

A user 205 may create data structures 414 using a data structure editor residing within the user interface module 222. Once created, each data structure 414 is reusable and may be used by different users 205 to extract data from the data sources 250-275.

Referring back to FIG. 4A, data processing layer 420 includes multiple components 422 stored in one or more libraries 424. Each component 422 is a reusable logic object that performs a specific task within the data processing layer 420, for example iterations, control flow, counter, and SQL operations, such as query, insert, update, delete. Each component 422 may be stored and accessed through libraries 424, which are dynamically recompiled and reloaded at runtime. A user 205 may create components 422 using a component editor residing within the user interface module 222.

Data processing layer 420 further includes one or more processes 428 stored in a processing module 426. Each process 428 uses predetermined sets of components 422, linked together to process data retrieved from data sources 250-275.

Each process 428 is defined by the corresponding set of components 422, and by a data model structure 425, which defines and stores pieces of data read and written by the process 428. A user 205 may define processes 428 using a process editor residing within the user interface module 222. Processes 428 will be described in further detail below.

In one embodiment, data model structure 425 is visible only to its corresponding process 428 and includes properties that define each data item retrieved from data sources 250-275, for example Input, Output, In-Out, or Static, optionality, and whether each data item is secure or not. Alternatively, each data model structure 425 may be transparent and, as a result, accessible to all processes 428 defined within the processing module 426. In one embodiment, data model structures 425 may be nested and may form a nested structure.

Referring back to FIG. 4A, presentation layer 430 includes multiple views 432, which allow users 205 to view processed data. In one embodiment, views 432 are Java Server Page (JSP) views. Each JSP view 432 is a dynamic page, for example an HTML page, which supports event-based input mechanisms and contains special tags interpretable by the server 210. Alternatively, views 432 may be presented in eXtensible Markup Language (XML). In one embodiment, each XML view 432 is an XML document accessible to users 205 via Universal Resource Locators (URLs).

Each view 432 includes a mechanism for triggering an action 434 and sets of data transmitted from the data model structures 425 and formatted for the type of view, for example in JSP or XML formats. In one embodiment, actions 434 reside within presentation layer 430 and provide a linkage between users 205 and processes 428. Each action 434 is coupled to one or more views 432 that can trigger that action. Also, each action 434 is further coupled to a process 428 triggered by the action and to a set of views 434 that must be activated after the process 428 concludes.

FIG. 4B is a block diagram of one embodiment for a user interface module. As illustrated in FIG. 4B, the user interface module 222 includes a data reference editor 416 to define one or more data reference structures 412 within the data access layer 410 of the application 400 and a data structure editor 418 to create one or more data structures 414 within the data access layer 410.

User interface module 222 further includes a component editor 423 to create sets of components 422 within the data processing layer 420 of the application 400 and a process editor 427 to define and run processes 428 within the data processing layer 420. A data model editor 429 is further provided within the user interface module 222 to define data model structures 425 for processes 428.

User interface module 222 further includes a view editor 433 to create one or more views 432 within the presentation layer 430 of the application 400 and an action editor 435 to define actions 434 within the presentation layer 430. In one embodiment, an XML editor 437 is provided within user interface module 222 to create views 432 presented in XML format and an XML transform editor 436 is further provided to convert documents created in a source format from a source Document Type Definition (DTD), for example XML, to a target DTD, for example HTML, and to present the document to users in the target format defined by the target DTD.

User interface module 222 further includes an application editor 438 to enable user 205 to create visually an application and to manipulate application components of the application in an application layout displayed for the user 205, as described in further detail below.

In one embodiment, user interface module 222 further includes templates 440. The editors within user interface module 222 use templates 440 to create or define corresponding structures for the application 400.

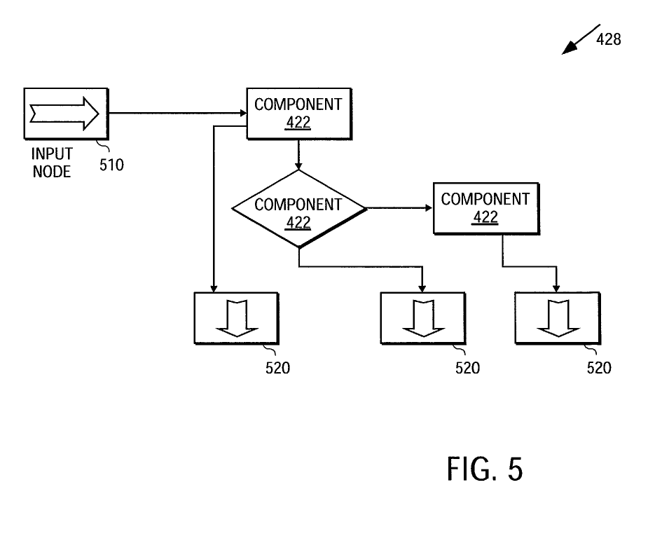

FIG. 5 is a block diagram of one embodiment for a process within the application 400. As illustrated in FIG. 5, in one embodiment, a process 428 includes an input node or process request 510, which receives multiple input parameters from user 205 through one or more views 432. Input node 510 is coupled to one or more components 422, which contain the logic of the process 428 and perform specific logic tasks. Each component 422 has a single point of entry and produces a set of responses 520. Each response 520 represents a result of process 428 and is returned to an action 434 that invoked the process 428. In one embodiment, the action 434 that triggered the process 428 associates each response 520 to a view 432 to be transmitted back to user 205.

Processes 428 can be linked by mapping a response 520 of one process 428 to an input node 510 of another process 428. Processes 428 may also be nested, wherein one process 428 may operate within another process 428.

One or more data model structures 425 are defined for each process 428. The input parameters received at the input node 510 and output parameters within responses 520 are mapped to the data model structures 425 to provide data persistence for the duration of the execution of the process 428.

In one embodiment, components 422 are standard for each process 428. For example, condition components provide binary decision processing, process data components define operations to be performed on data sources, and iteration components provide data fetching and simplify the configuration of process 428. Alternatively, components 422 may be custom created for each process 428 by defining the corresponding data model structures 425 and the set of responses 520.

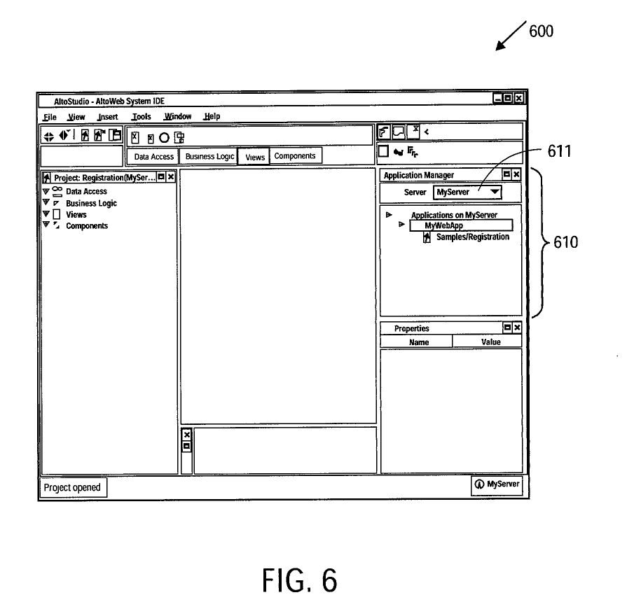

FIG. 6 illustrates one embodiment of a user interface to define the application 400 within the system. In one embodiment, user 205 defines the application through the user interface module 222 within client 220.

As illustrated in FIG. 6, in one embodiment, interface 600 includes an Application Manager window area 610, which displays applications 400 defined within client 220 as nodes of a hierarchical tree structure. The applications are associated with the application server 210 or with multiple servers similar to server 210. The application server 210 is selected through a MyServer pull-down menu 611 located within the Application Manager window area 610.

The Application Manager window area 610 allows the user 205 to manage the defined applications using conventional mouse commands. In one embodiment, user 205 selects an application MyWebApp within the hierarchical tree structure displayed in window area 610 using a mouse left-click command. Once the selected application is highlighted within the tree structure, user 205 can open a menu associated with the selected application using a mouse right-click command, as described in further detail below.

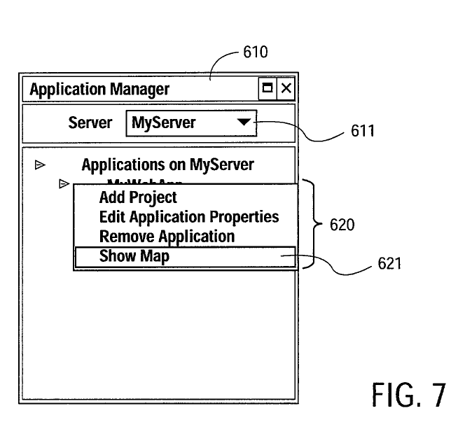

FIG. 7 illustrates one embodiment of the Application Manager window area 610 within the interface 600. As illustrated in FIG. 7, in one embodiment, subsequent to the mouse right-click command on the highlighted application MyWebApp 400, a menu 620 opens within the Application Manager window area 610, the menu 620 being associated with the selected application.

The menu 620 enables the user 205 to perform certain operations on the selected application 400, for example, to edit properties of the selected application, to remove the selected application from the selected server, or to access and display an application layout of the selected application 400 in a separate user interface area. In one embodiment, the user 205 selects a ShowMap field 621 within the menu 620 using a mouse left-click command to display the application layout of the selected application.

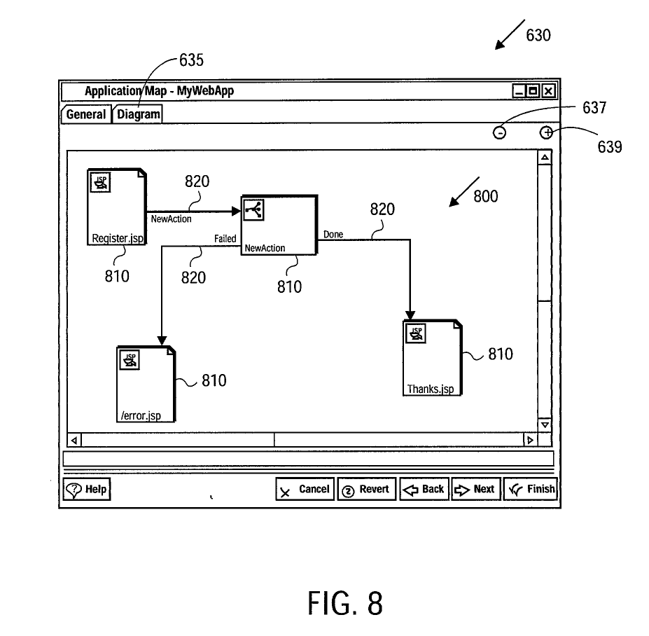

FIG. 8 illustrates one embodiment of a first user interface area to display an application layout of a selected application. As illustrated in FIG. 8, in one embodiment, subsequent to the selection of the ShowMap field 621 within the menu 620, user 205 accesses the application editor 438, which presents a first user interface area 630 to the user 205. In order to access the application layout of the selected application, user 205 selects a Diagram tab 635 within the first user interface area 630. Subsequent to the selection of the Diagram tab 635, the application editor 438 displays application layout 800 in the first user interface area 630. In one embodiment, application layout 800 includes multiple application icons 810 interconnected through multiple connections 820, each application icon 810 corresponding to an application component of the selected application, for example, a business logic component or process 428, an action component 434, a view component 432, or a data structure component 414.

On the initial access, the application editor 438 computes the positions of each application icon 810 and each connection 820 in order to initiate the application layout 800. In one embodiment, the first user interface area 630 enables the user 205 to visually modify the application layout 800 using conventional mouse click commands. For example, the first user interface area 630 enables the user 205 to select an application icon 810 using a mouse left-click command. The application editor 438 facilitates the selection of the icon 810 within the first user interface area 630. As a result, the selected application icon 810 and all connections 820 to the icon 810 are redisplayed in a highlighted color within the application layout 800. At the same time, the name of the application component corresponding to the selected application icon 810 is displayed in a message field at the bottom of the first user interface area 630.

Furthermore, in one embodiment, the first user interface area 630 enables the user 205 to select an application icon 810 through a mouse left-click command and to modify the position of the selected application icon 810 within the application layout 800 by dragging the selected icon 810 to a new position. The application editor 438 facilitates the selection of the icon 810 and the visual modification of its position. In addition, the application editor 438 facilitates repositioning of one or more application icons 810 connected to the selected application icon 810 within the application layout 800.

In one embodiment, the first user interface area 630 enables the user 205 to select a connection 820 through a mouse left-click command and to modify the connection 820 within the application layout 800. The application editor 438 facilitates the selection of the connection 820 and its visual modification. In one embodiment, the user 205 is enabled to visually modify a type of the connection 820 through a mouse left double-click command on the connection 820. The type of the connection 820 toggles between a two-point default connection and a multi-point connection.

Alternatively, the user 205 may visually modify a position of the connection 820 by dragging the selected connection 820 to a new position within the application layout 800. Moreover, the user 205 may display the connection points of the selected connection 820 using a mouse left-click command on the connection. As a result, the connection points are drawn and displayed in the application layout 800.

Each connection point of the selected connection 820 may be visually accessed by the user 205 in the first user interface area 630 through a mouse right-click command on the connection point. Subsequently, a connection point popup menu (not shown) is displayed to enable the user 205 to perform operations associated with the connection point, for example, to add/remove a connection point to/from the selected connection 820.

The first user interface area 630 enables the user 205 to select a connection point of a connection 820 through a mouse left-click command and to modify the position of the selected connection point within the application layout 800 by dragging the connection point to a new position. The application editor 438 facilitates the selection of the connection point and the visual modification of its position. In addition, the application editor 438 facilitates repositioning of one or more application icons 810 connected to the selected connection point within the application layout 800.

In one embodiment, the first user interface area 630 enables the user 205 to select a destination file to store the application layout 800. The application editor 438 facilitates the visual selection of the destination file and the storage of the application layout 800 in the destination file. The application layout 800 is stored as an image file using one of many known storage formats, for example, the JPEG format. A layout popup menu (not shown) is displayed, subsequent to a mouse right-click command on the application layout 800 within the user interface area 630, to allow the user 205 to select the destination file and to save the image of the application layout 800. The image file will reflect the current scale of the application layout 800 and current selections within the application layout 800, such as icon, connection, or connection point selections, are reset.

In one embodiment, the first user interface area 630 further includes an interactive Zoom In “−” button 637 and an interactive Zoom Out “+” button 639 to enable the user 205 to scale the application layout 800 through mouse click commands. The user 205 may decrease the size of the application layout 800 by clicking on the Zoom In button 637 or may increase the size of the application layout by a predetermined factor by clicking on the Zoom Out button 639. If an application icon 810 has been previously selected, the user 205 may center a scaled view of the application layout 800 on the selected application icon 810 by using a mouse right-drag command on the application layout 800.

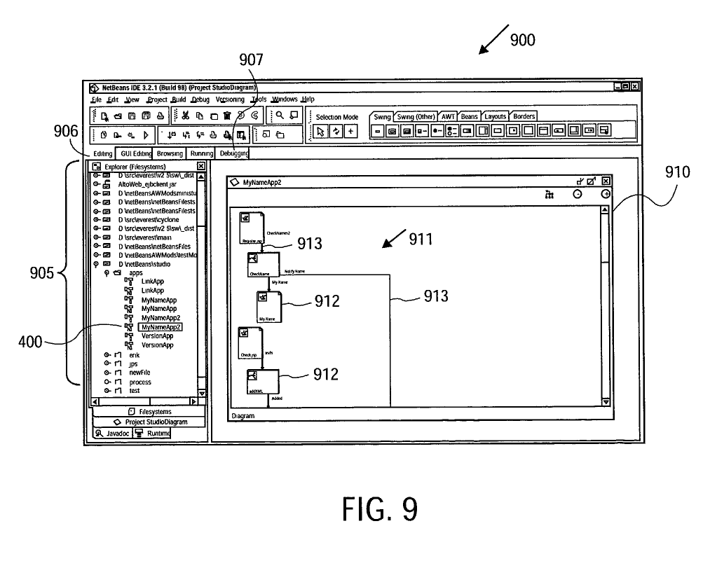

FIG. 9 illustrates an alternate embodiment of a first user interface area to display an application layout of a selected application. As illustrated in FIG. 9, the user interface 900 includes an interactive file window area 905, which displays applications 400 associated with a selected server in a hierarchical tree structure. The file window area 905 enables the user 205 to select and visually access an application 400, such as, for example, the MyNameApp2 application displayed within the tree structure.

The application editor 438 facilitates the display of an application layout 911 of the selected application 400 in an interactive first user interface area 910 within the user interface 900. The user 205 selects an Editing tab 906 within the user interface 900 with a mouse left-click command in order to access and visually modify the displayed application layout 911. In one embodiment, as described in detail above, the application layout 911 includes multiple application icons 912 dynamically linked through multiple connections 913, each application icon 912 corresponding to an application component of the selected application 400.

In one embodiment, the user 205 may select a Debugging tab 907 within the user interface 900 with a mouse left-click command in order to visually analyze and remove errors from the selected application, i.e. debug the application, as described in further detail below.

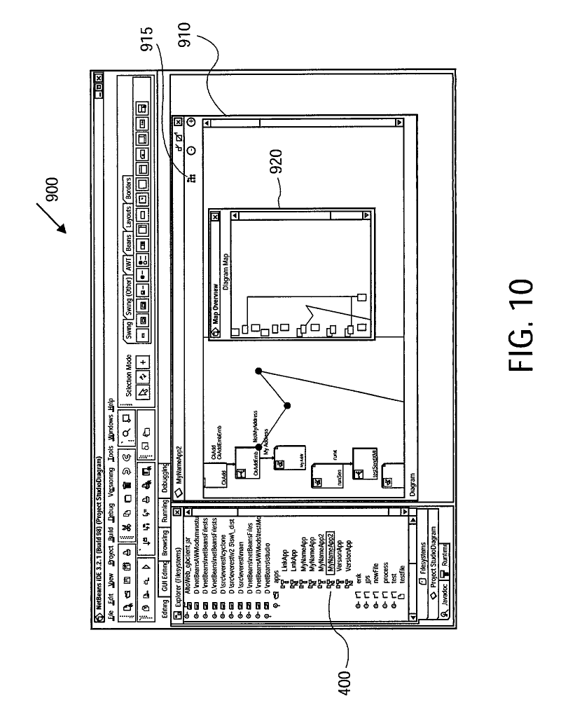

FIG. 10 illustrates an interactive window area within the first user interface area 910 to display a scaled rendering of the application layout 911. As illustrated in FIG. 10, in one embodiment, the first user interface area 910 enables the user 205 to select an Overview button 915 with a mouse click command. Subsequent to the selection, the application editor 438 facilitates the presentation of the interactive window area 920 to display a scaled rendering of the application layout 911. The interactive window area 920 is dynamically linked to the first user interface area 910, such that any selection of an application icon 912 in one area is simultaneously reflected in the other area.

The interactive window area 920 is moveable and sizeable by the user 205 through conventional mouse click commands. The scaled rendering of the application layout 911 is interactively displayed at a predetermined scale and assists the user 205 in navigation of a complex application layout 911. For example, the user 205 selects an application icon 912 within the interactive window area 920 and the application editor 438 facilitates a simultaneous selection of the selected application icon 912 in the application layout 911 within the first user interface area 910, such that a scroll pane for the application layout 911 will scroll to the location of selected application icon 912.

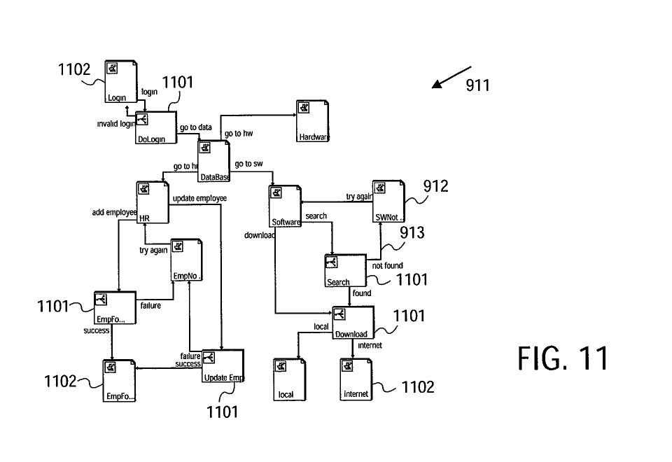

FIG. 11 illustrates a block diagram of an application layout 911 displayed within the first user interface area 910. As illustrated in FIG. 11, in one embodiment, the application layout 911 includes multiple application icons 912 dynamically linked through multiple connections 913, each application icon 912 corresponding to an application component of the selected application 400. For example, application icons 912 include icons 1101 corresponding to actions 434 within the application 400 and icons 1102 corresponding to views 432 within the application 400, such as, for example, Java Server Page (JSP) views. Each application icon 912 connects to one or more adjacent application icons 912 via two-point or multi-point connections 913.

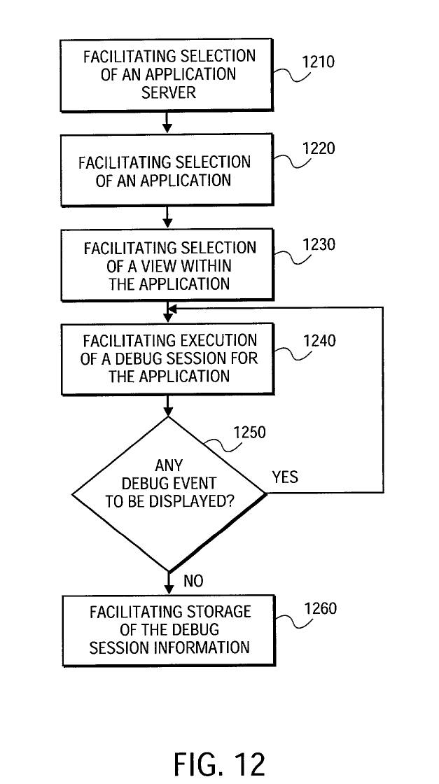

FIG. 12 illustrates one embodiment of a method to facilitate analysis and removal of errors from an application. As illustrated in FIG. 12, at processing block 1210, selection of an application server 210 is facilitated, as described in further detail below.

At processing block 1220, selection of an application 400 stored within the selected application server 210 is facilitated, as described in further detail below. At processing block 1230, selection of a view 432 within the selected application 400 is facilitated, as described in further detail below.

At processing block 1240, execution of a debug session is facilitated for the application 400, as described in further detail below. In one embodiment, each debug session includes multiple debug events, each debug event corresponding to one application component of the application 400. At processing block 1250, a decision is made whether any debug events are still to be displayed.

If debug events are still to be displayed, processing block 1240 is repeated. Otherwise, if no debug events need to be further displayed, at processing block 1260, storage of the debug session information is facilitated, as described in further detail below.

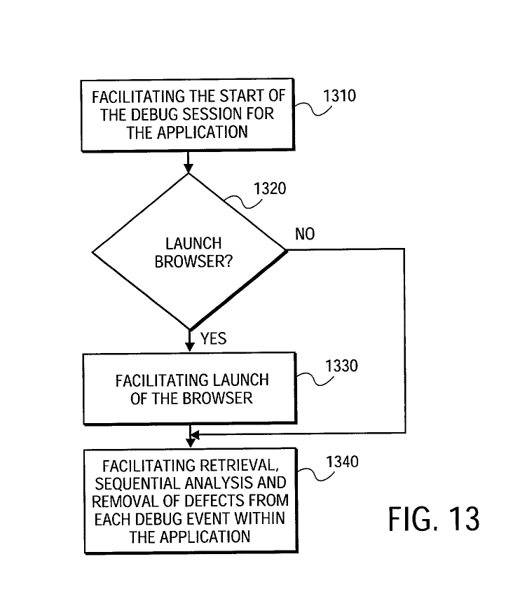

FIG. 13 illustrates one embodiment of an execution of a debug session within the method to facilitate analysis and removal of errors from an application. As illustrated in FIG. 13, at processing block 1310, the start of the debug session is facilitated, as described in further detail below.

At processing block 1320, a decision is made whether to launch a browser in a browser window area in order to enable the execution of the application 400. If the browser has to be launched, at processing block 1330, the launch of the browser is facilitated, as described in further detail below.

Otherwise, if the browser does not have to be launched, the process jumps to processing block 1340, where retrieval, sequential analysis and removal of errors from each debug event within the application 400 is facilitated, as described in further detail below.

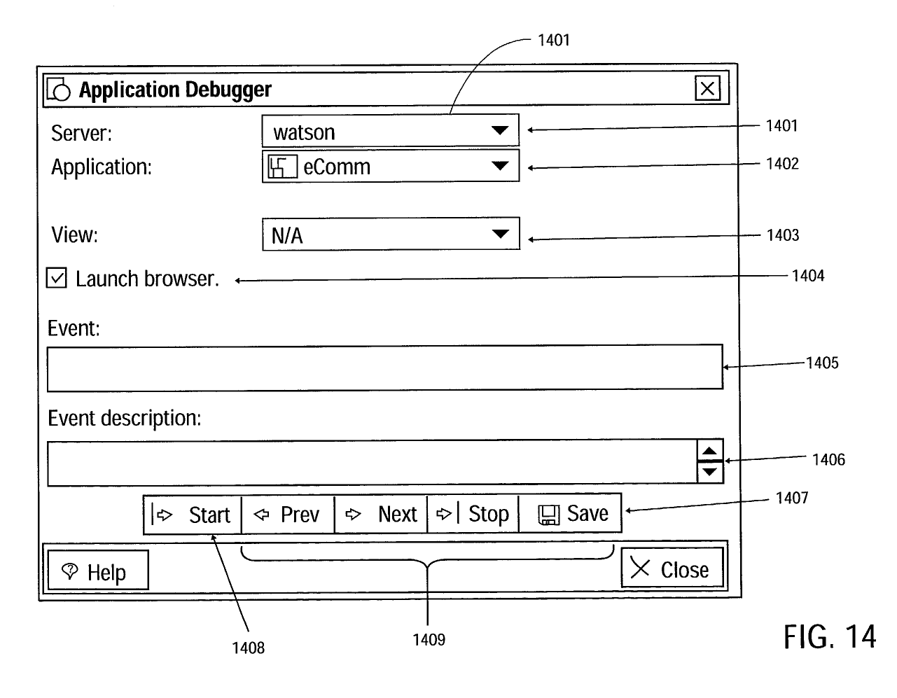

FIG. 14 illustrates an exemplary second user interface area to facilitate analysis and removal of errors from an application. As illustrated in FIG. 14, a second user interface area 1400 is displayed within the user interface 900. In one embodiment, as described above in connection with FIG. 9, the user 205 selects a Debugging tab 907 with a mouse left-click command in order to access the second user interface area 1400. Alternatively, the user 205 may select the application MyNameApp2 400 with a right-click command from the interactive file window area 905 and may access the second user interface area 1400 through a right-click mouse menu item (not shown).

In response to the user selection, the application editor 438 presents the second user interface area 1400 to facilitate debugging of the application 400. The second user interface area 1400 enables the user 205 to control all aspects of the debug session with the application server 210.

In one embodiment, the application 400 is in a deployed state. The second user interface area 1400 includes a server selection pull-down menu 1401 to enable the user 205 to select the application server 210, which stores the application 400 that needs to be accessed, using conventional mouse click commands. The second user interface area 1400 further includes an application selection pull-down menu 1402 to enable the user 205 to select the application 400. In addition, the second user interface area includes a component selection pull-down menu 1403 to enable the user 205 to select a starting component of the application 400, for example a view component 432. The combination of the server 210, application 400, and view 432 selections constitute the initial page selection of the application 400. If a browser is launched in a browser window area, the page represented by the above user selections will be loaded in the browser window area.

The second user interface area 1400 further includes a Launch browser check box 1404 to enable the user 205 to select the launch of the browser. If the Launch browser check box 1404 is selected by the user 205 with a mouse left-click command, the browser is launched and loaded with the user selected page at the time the user 205 starts the debug session by selecting a Start button 1408 within the second user interface area 1400. If the Launch browser check box 1404 is not selected by the user 205, the browser is not launched upon the start of the debug session.

The second user interface area 1400 further includes an event list pane 1405 to facilitate the display of a condensed, one-line description of debug events within the debug session. In one embodiment, the debug events are application components of the application 400, such as, for example, views 432, actions 434, or processes 428. A current application icon 912 corresponding to a selected debug event is highlighted within the application layout 911 in the first user interface area 910, as described in further detail below.

The second user interface area 1400 further includes an event description pane 1406 to facilitate the display of detailed information related to the selected debug event within the event list pane 1405. A toolbar 1407 within the second user interface area 1400 contains interactive buttons to enable the user 205 to control the debug session and to navigate the debug events within the debug session. If selected, a Start button 1408 within the toolbar 1407 enables the user 205 to start the debug session and to retrieve the first debug event. The application editor 438 facilitates retrieval of the first debug event from the application server 210. Any available information regarding the debug event will be displayed in the event description pane 1406. Once selected, the Start button 1408 will be disabled and navigation buttons 1409 within the toolbar 1407 will be enabled for use by the user 205.

In one embodiment, a Prev button of the navigation buttons 1409 enables the user 205 to move the selected debug event down in the debug session. The Prev button is inoperative for selection beyond the first debug event. If selected, a Next button of the navigation buttons 1409 enables the user 205 to move the selected debug event up in the debug session. If the previously selected debug event is at the end of the debug session, an attempt to retrieve the next event from the application server 210 will be invoked. If no more events are available, the debug session will be closed and the selected debug event will wrap to the first debug event of the debug session. If selected, a Stop button of the navigation buttons 1409 enables the user 205 to stop the debug session. As a result, all buttons, except the Start button 1408 will be disabled. If selected, a Save button of the navigation buttons 1409 allows the user 205 to save debug event information currently displayed in the event list pane 1405 to a debugging destination file. The application editor 438 facilitates selection of the debugging destination file to save the debug session information and facilitates the storage of the debug session information in the debugging destination file.

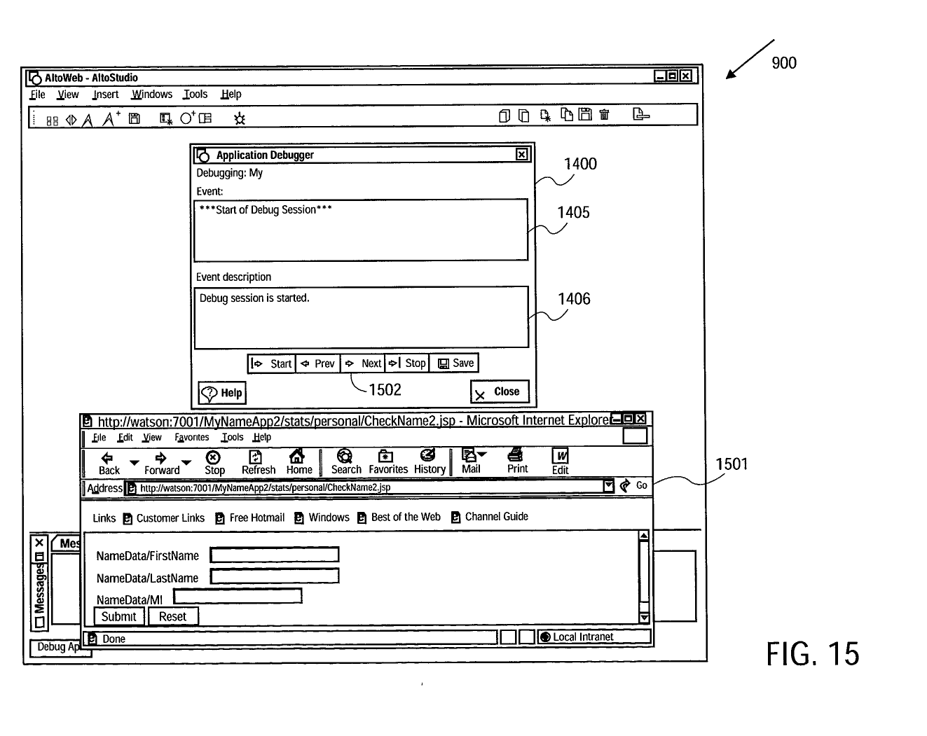

FIG. 15 illustrates the second user interface area and an exemplary browser window area displayed upon launch of a browser. As illustrated in FIG. 15, in one embodiment, subsequent to the selection of the application server 210 in the server menu 1401, the selection of the application MyNameApp2 400 in the application menu 1402, and the selection of a view 432, such as, for example, a CheckNames2 view in the component menu 1403, if the decision is made to launch the browser in a browser window area 1501, the user 205 selects the Launch browser check box 1404 to launch the browser. The browser window area 1501 is displayed within the user interface 900 and the browser loads the selected page, as described in detail above. The debug description in the event description pane 1406 indicates that the debug session has been started. The description within the event list pane 1405 indicates the Start of Debug Session. Subsequent to the execution of the application 400, the user 205 selects the Next button 1502 within the navigation buttons 1409 in order to retrieve the first debug event.

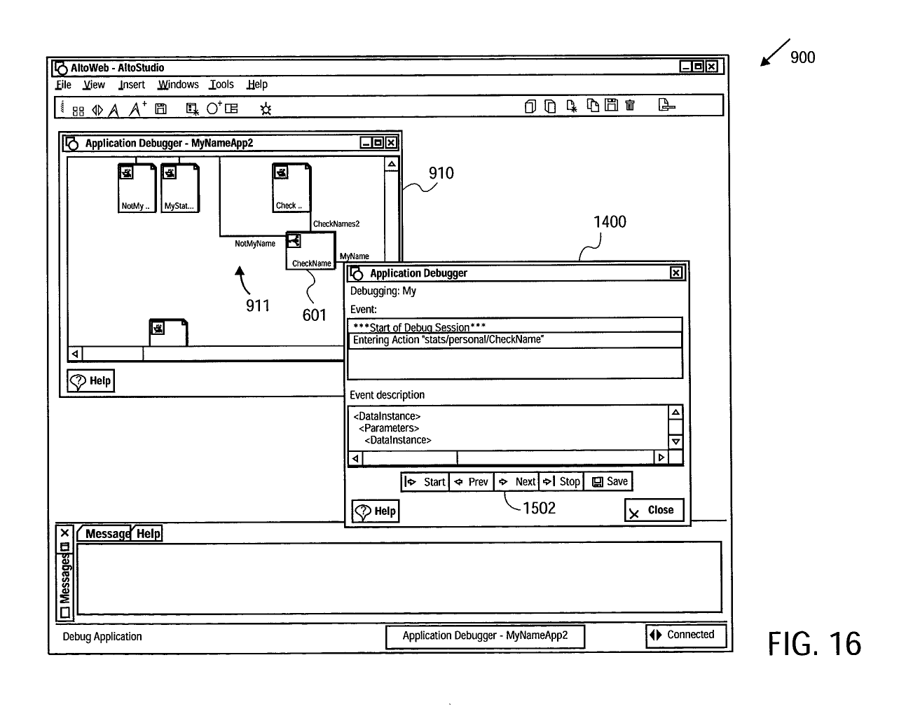

FIG. 16 illustrates the exemplary first and second user interface areas. As illustrated in FIG. 16, the first user interface area 910 and the second user interface 1400 are displayed within the user interface 900. The first user interface area 910 displays the application layout 911 of the application 400 and the second user interface area 1400 displays debug session information. In one embodiment, subsequent to the execution of the application 400, and the selection of the Next button 1502, a starting component of the application 400 is selected, and an application icon 1601 corresponding to the starting component is highlighted in the application layout 911. In one embodiment the starting component is a JSP view component. Alternatively, the starting component is an action component, such as, for example, a stats/personal/CheckName action of the application MyNameApp2 400 shown in FIG. 16. Subsequently, the user 205 selects again the Next button 1502 with a mouse left-click command in order to retrieve the next application component or debug event.

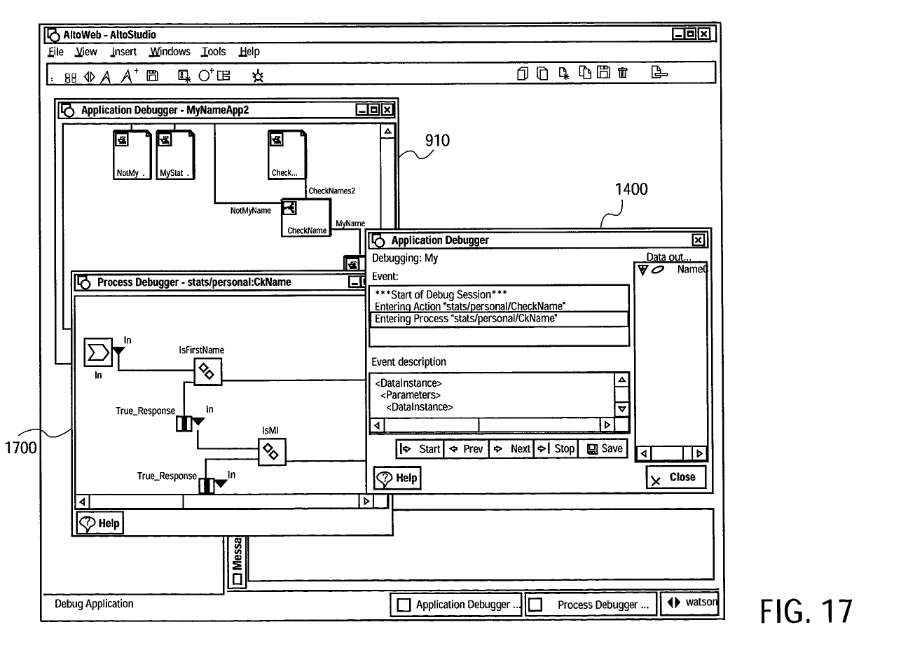

FIG. 17 illustrates an exemplary third user interface area to display a process layout of a process 428 of the application 400. As illustrated in FIG. 17, if the next application component or debug event is a process 428, such as, for example, a stats/personal/CkName process invoked by the action “CheckName” described above, a third user interface area 1700 is displayed to allow the display of the process 428. Processes 428 within the application 400 are complex and incorporate several process components 422, responses 520, and connection between the process components 422. In addition, process components 422 have several connections to other components and may include several connections to the same component 422. In one embodiment, the process editor 427 facilitates the display of the third user interface area 1700 to enable the user 205 to debug the process 428 within the second user interface area 1400, such as, for example, to identify the source of process errors and to refine the flow of the process 428. Alternatively, the user 205 may directly test and debug a process 428, as described in further detail below.

As the debug session continues, in one embodiment, processes 428 associated with actions 434 of the application 400 will be displayed in additional user interface areas as necessary. The additional user interface areas will be opened and closed, as appropriate during the debug session.

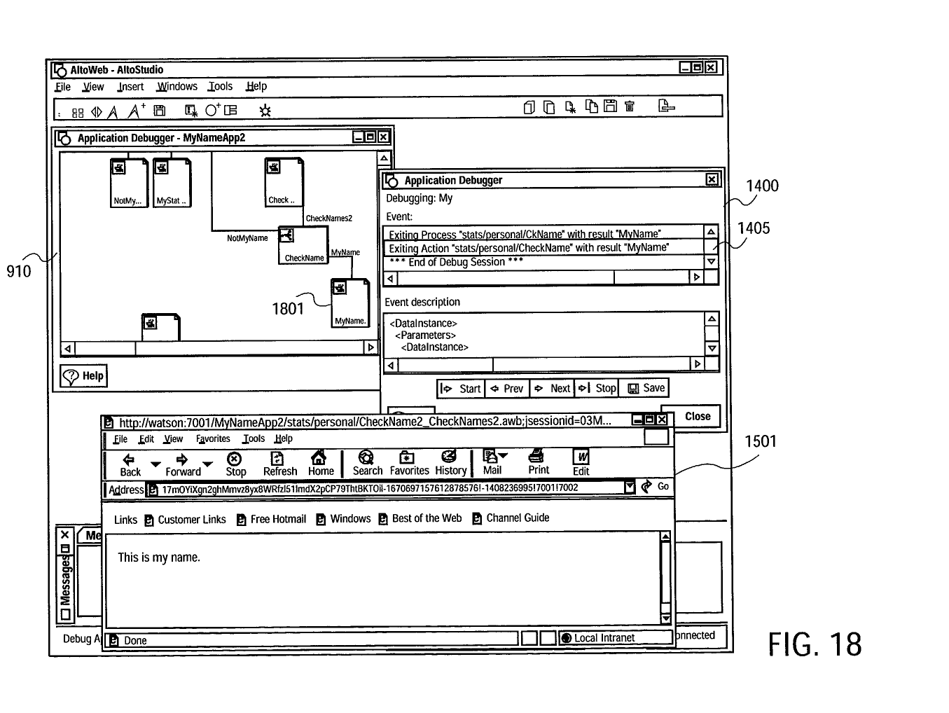

FIG. 18 illustrates the first and second user interface areas and the browser window area at the conclusion of an error-free debug session. As illustrated in FIG. 18, in one embodiment, if the next application component or debug event is the last debug event in the debug session, the first user interface area 910 displays an application icon 1801 corresponding to a response 520 produced by the process component 428 in a highlighted color. The second user interface area 1400 displays an “End of Debug Session” message in the event list pane 1405 and stops the execution of the debug session for the application 400. The browser window area 1501 displays the actual response 520 produced by the process component 428, which corresponds to the page displayed in the browser, such as, for example, the “This is my name” message. If errors are found during the debug session, the error event is displayed in the first and second user interface areas, as well as in the browser window area, as described in further detail below. In one embodiment, the user 205 may traverse the debug events in reverse order after the end of the debug session or during the debug session to review the previously considered debug events.

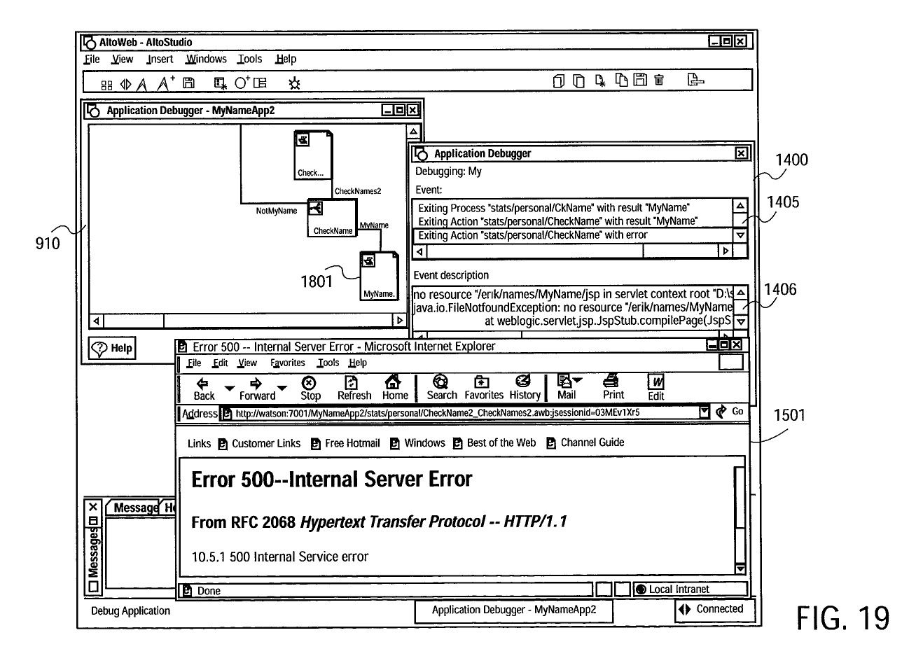

FIG. 19 illustrates the first and second user interface areas and the browser window area, at the conclusion of a debug session resulting in errors. As illustrated in FIG. 19, if the debug session results in an error event, for example, on the action component CheckName described above, the first user interface area 910 displays the last debug event, as well as the application icon 1801 corresponding to the response 520 in a different highlighted color. In the event list pane 1405 of the second user interface area 1400, an error message linking the error to the specific debug event is displayed. Further, in the event description pane 1406 of the second user interface area 1400 a description of the error event is displayed to enable the user 205 to correct or remove the error. The browser window area 1501 displays an error message, which corresponds to the page displayed in the browser.

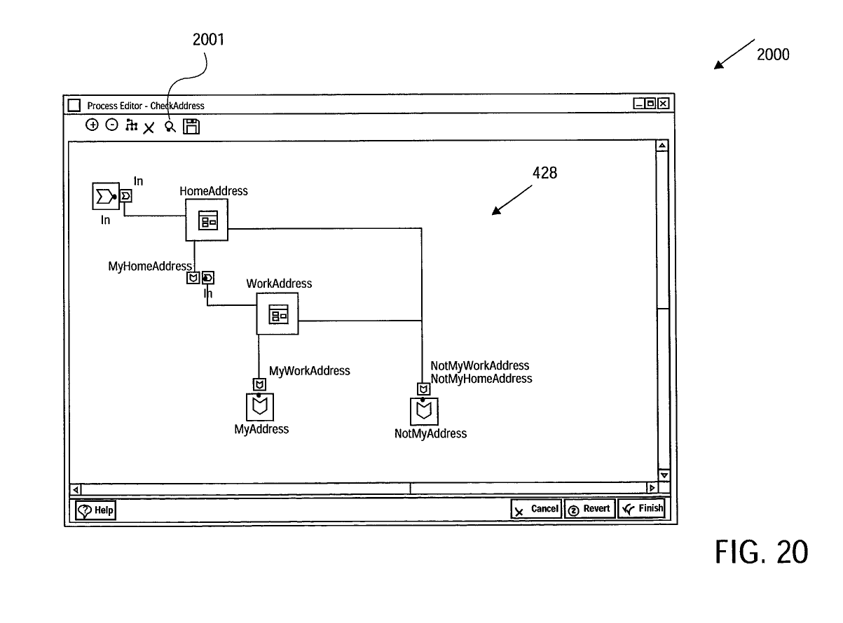

FIG. 20 illustrates an exemplary process editor window area within the user interface 900 to display a process 428 within the application 400. As illustrated in FIG. 20, the process editor 427 facilitates the display of a process editor window area 2000 to enable the user 205 to visualize the process 428. The process editor window area 2000 displays the process 428 and allows the user 205 to select a Test button 2001 to visually test and debug the process 428.

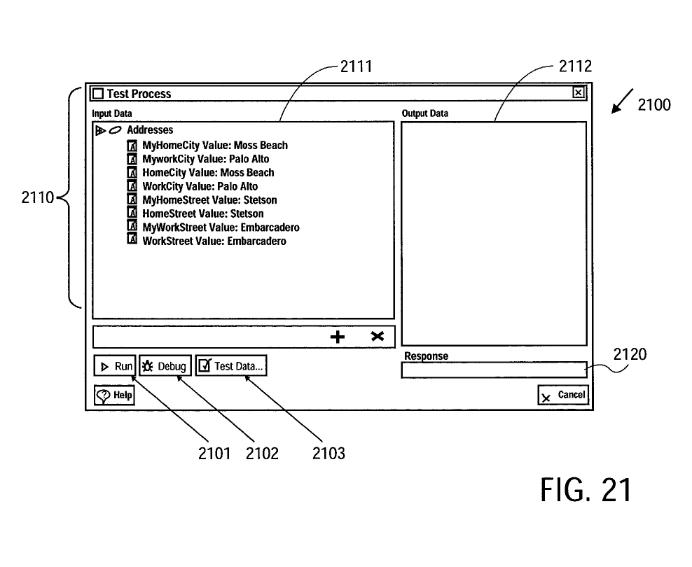

FIG. 21 illustrates an exemplary process test interface area to test and debug the process 428. As illustrated in FIG. 21, in one embodiment, upon selection by the user 205 of the Test button 2001 with a conventional mouse click command, the process editor facilitates display of a process test interface area 2100 to enable the user 205 to test and debug the process 428 within the application 400.

The process test interface area 2100 includes, in one embodiment, a Run panel 2110 to display input and output data for the process 428. The Run panel 2110 includes an input data window area 2111 to display the input data and an output data window area 2112 to display the output data. The process test interface area 2100 further includes a Response field 2120 to display a result of the execution of the process 428, such as, for example, a response 520 of the process 428.

The process test interface area 2100 includes, in one embodiment, a Run button 2101 to enable the user 205 to run the process 428, a Debug button 2102 to enable the user 205 to debug the process 428, and a Test Data button 2103 to enable the user 205 to manage the test data for the process 428.

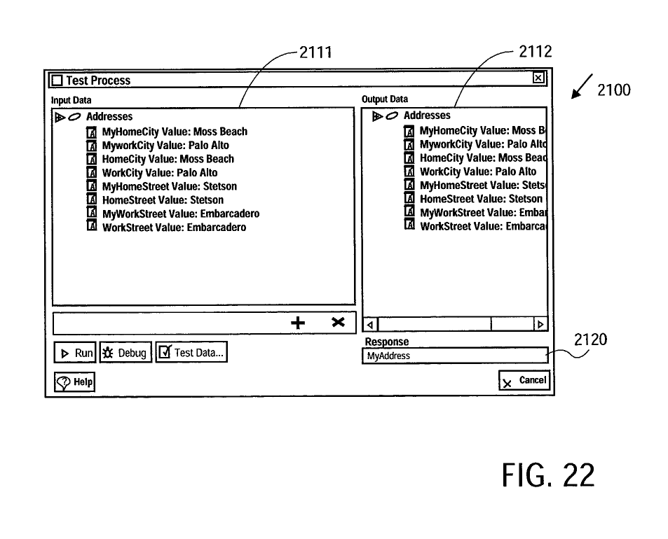

The user 205 selects the Run button 2101 with a mouse left-click command to run the process 428 using the input data displayed within the input data window area 2111 of the Run panel 2110. The process editor 427 facilitates the execution of the process 428 and displays results in the Response field 2120. FIG. 22 illustrates the process test interface area 2100 displaying results of the execution of the process 428. As illustrated in FIG. 22, subsequent to the selection of the Run button 2101, the process editor 427 runs the process 428 and displays a response 520 in the Response field 2120. Simultaneously, the process editor 427 populates the output data window area 2112 with the output data.

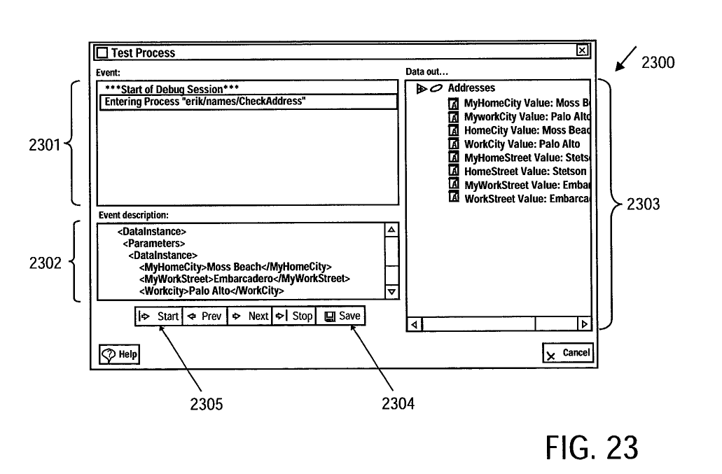

Referring back to FIG. 21, the user 205 selects the Debug button 2102 with a mouse left-click command to debug the process 428. The process editor 427 facilitates execution of the process 428 and displays a process debug interface area described in further detail below. FIG. 23 illustrates an exemplary process debug interface area 2300 to debug the process 428. As illustrated in FIG. 23, the process debug interface area 2300 is displayed in lieu of the Run panel 2110 of the process test window area 2100.

In one embodiment, the process debug interface area 2300 includes an event list pane 2301 to display a condensed, one-line description of the events contained in the process debug session, and an event description pane 2302 to display detailed information of the selected event in the event list pane 2301. A current event within the event list pane 2301 is highlighted to identify the relative location of the event within the debug session. The process debug interface area 2300 further includes a data model window area 2303 to display the data model structure 425 for the process 428 in a hierarchical tree structure. The data model window area 2303 enables the user 205 to expand and/or collapse the data model structure 425 in the tree structure.

The process debug interface area 2300 further includes a toolbar 2304 containing multiple interactive buttons enabling the user 205 to control the debug session and to navigate the debug events. If selected, a Start button 2305 within the toolbar 2304 enables the user 205 to start the debug session and to retrieve the first debug event. The process editor 427 facilitates retrieval of the first debug event from the application server 210 upon selection of the Start button 2305 with a mouse left-click command. Any available information regarding the debug event will be displayed in the event description pane 2302. Once selected, the Start button 2305 will be disabled and other navigation buttons within the toolbar 1407 will be enabled for use by the user 205.

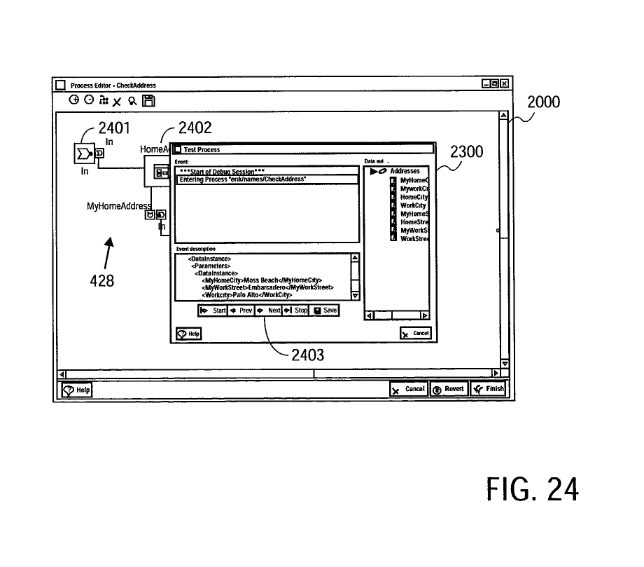

FIG. 24 illustrates the process editor window area 2000 to display the process 428 and the process debug interface area 2300 to facilitate display of a debug session of the process 428. As illustrated in FIG. 24, in one embodiment, subsequent to the retrieval of the first debug event, the process editor window area 2000 displays the highlighted debug event, such as, for example an input node 2401. The process debug interface area 2300 facilitates the definition of the input node event 2401 in the event list pane 2301 and the display of information associated with the Input node event 2401 in the event description pane 2302.

In one embodiment, the input node event 2401 of the process 428 is connected to an inline process 2402, which may be encountered during the debug session. The inline process 2402 may be selected by the user 205 through selection of a Next button 2403 with a mouse left-click command, which prompts the process editor 427 to retrieve the next debug event. Subsequently, the process editor 427 facilitates the display of the inline process 2402 in lieu of the main process 428.

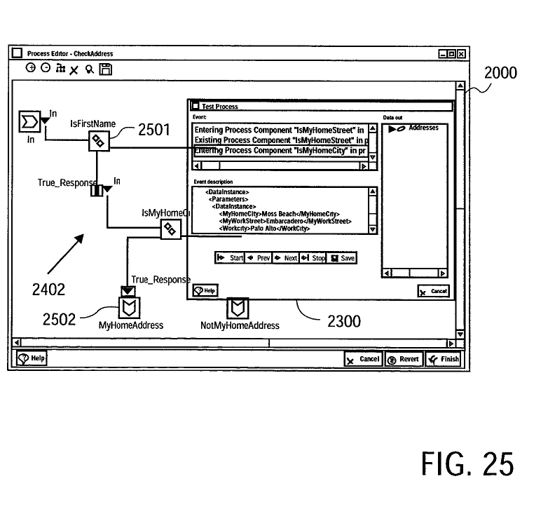

FIG. 25 illustrates the process editor window area 2000 to display an inline process 2402 and the process debug interface area 2300 to facilitate display of a debug session of the inline process 2402. As illustrated in FIG. 25, subsequent to the retrieval of the inline process 2402, the process editor window area 2300 displays the inline process 2402 and indicates a first component event 2501 within the debug session in a highlighted color. The process debug interface area 2300 displays a debug session for the selected inline process 2402. As a result, the event list pane 2301 displays the short description of the starting component event 2501 and the event description pane 2302 displays information associated with the event 2501. The process editor 427 further facilitates execution of the debug session of the inline process 2402 through all the component events of the inline process 2402. Upon exiting the debug session for the inline process 2402, the inline process 2402 is closed and the process editor window area 2000 displays the main process 428. At the conclusion of the debug session for the main process 428, the process editor window area 2000 displays a result of the execution of process 428 in a highlighted color, such as a response 2502, which is consistent with the response displayed in the Response field 2120 shown in FIG. 22.

In one embodiment, the process 428 may include one or more embedded process components 422, which have a single input and one or more responses 520 and allow the user 205 to reuse previously developed processes in the same application 400 or in different applications. When an embedded component 422 is encountered in the process 428, the process flow is redirected to the embedded process associated with that embedded component. Once the embedded process finishes execution, the process flow returns to the execution of the process 428.

If the user 205 selects the Next button 2403 and, in response to the selection, the process editor 427 facilitates retrieval of an embedded process component of the process 428, the embedded process associated with the selected embedded process component is displayed in a separate window area presented by the process editor 427, which will remain open until the debug session of the embedded process concludes and the operation is reverted back to the debug session of the process 428. In one embodiment, if the embedded process further includes another embedded component that is linked to a further embedded process, multiple window areas may be presented by the process editor 427 to display the embedded processes and to enable the user 205 to debug each embedded process.

It is to be understood that embodiments of this invention may be used as or to support software programs executed upon some form of processing core (such as the CPU of a computer) or otherwise implemented or realized upon or within a machine or computer readable medium. A machine readable medium includes any mechanism for storing or transmitting information in a form readable by a machine (e.g., a computer). For example, a machine readable medium includes read-only memory (ROM); random access memory (RAM); magnetic disk storage media; optical storage media; flash memory devices; electrical, optical, acoustical or other form of propagated signals (e.g., carrier waves, infrared signals, digital signals, etc.); or any other type of media suitable for storing or transmitting information.

In the foregoing specification, the invention has been described with reference to specific exemplary embodiments thereof. It will, however, be evident that various modifications and changes may be made thereto without departing from the broader spirit and scope of the invention as set forth in the appended claims. The specification and drawings are, accordingly, to be regarded in an illustrative rather than a restrictive sense.

What is claimed is:

1. A method to facilitate visual analysis and removal of errors from an application to provide data to a user, said method comprising:
presenting a first user interface area to display an application layout of said application, said application layout comprising a plurality of application icons and at least one connection that connects said plurality of application icons, each application icon corresponding to an application component of said application; and
presenting a second user interface area to enable said user to execute said application and to run a debug session in order to visually remove said errors from each application component of said application displayed within said first user interface area.

2. The method according to claim 1, wherein presenting said second user interface area further comprises:
facilitating selection of an application server, which stores said application, from a server menu displayed within said second user interface area;
facilitating selection of said application from an application menu displayed within said second user interface area; and
facilitating selection of a starting component of said application from a component menu displayed within said second user interface area.

3. The method according to claim 1, wherein presenting said second user interface area further comprises:
facilitating loading of a browser in a browser window area to execute said application.

4. The method according to claim 3, wherein said browser displays in said browser window area a page defined by said application server, said application, and said starting component.

5. The method according to claim ², wherein presenting said second user interface area further comprises:
facilitating retrieval of said each application component from said application server; and
facilitating visual sequential analysis and removal of errors from said each application component.

6. The method according to claim 1, wherein presenting said second user interface area further comprises:
facilitating selection of a debugging destination file to save debug session information associated with said debug session; and
facilitating storage of said debug session information in said debugging destination file.

7. The method according to claim 2, wherein said starting component is a Java Server Page (JSP) view component.

8. The method according to claim 2, wherein said starting component is an action component.

9. The method according to claim 5, further comprising:
facilitating retrieval of a process component of said application; and
presenting a third user interface area to facilitate analysis and removal of errors from said process component.

10. A system to facilitate visual analysis and removal of errors from an application to provide data to a user, said system comprising:
means for presenting a first user interface area to display an application layout of said application, said application layout comprising a plurality of application icons and at least one connection that connects said plurality of application icons, each application icon corresponding to an application component of said application; and
means for presenting a second user interface area to enable said user to execute said application and to run a debug session in order to visually remove said errors from each application component of said application displayed within said first user interface area.

11. The system according to claim 10, further comprising:
means for facilitating selection of an application server, which stores said application, from a server menu displayed within said second user interface area;
means for facilitating selection of said application from an application menu displayed within said second user interface area; and
means for facilitating selection of a starting component of said application from a component menu displayed within said second user interface area.

12. The system according to claim 10, further comprising:
means for facilitating loading of a browser in a browser window area to execute said application.

13. The system according to claim 12, wherein said browser displays in said browser window area a page defined by said application server, said application, and said starting component.

14. The system according to claim 11, further comprising:
means for facilitating retrieval of said each application component from said application server;
means for facilitating visual sequential analysis and removal of errors from said each application component.

15. The system according to claim 10, further comprising:
means for facilitating selection of a debugging destination file to save debug session information associated with said debug session; and
means for facilitating storage of said debug session information in said debugging destination file.

16. The system according to claim 11, wherein said starting component is a Java Server Page (JSP) view component.

17. The system according to claim 11, wherein said starting component is an action component.

18. The system according to claim 14, further comprising:
means for facilitating retrieval of a process component of said application; and
means for presenting a third user interface area to facilitate analysis and removal of errors from said process component.

19. A computer readable medium containing executable instructions, which, when executed in a processing system, cause said processing system to perform a method comprising:
presenting a first user interface area to display an application layout of said application, said application layout comprising a plurality of application icons and at least one connection that connects said plurality of application icons, each application icon corresponding to an application component of said application; and
presenting a second user interface area to enable said user to execute said application and to run a debug session in order to visually remove said errors from each application component of said application displayed within said first user interface area.

20. The computer readable medium according to claim 19, wherein presenting said second user interface area further comprises:
facilitating selection of an application server, which stores said application, from a server menu displayed within said second user interface area;
facilitating selection of said application from an application menu displayed within said second user interface area; and
facilitating selection of a starting component of said application from a component menu displayed within said second user interface area.

21. The computer readable medium according to claim 19, wherein presenting said second user interface area further comprises:
facilitating loading of a browser in a browser window area to execute said application.

22. The computer readable medium according to claim 21, wherein said browser displays in said browser window area a page defined by said application server, said application, and said starting component.

23. The computer readable medium according to claim 20, wherein presenting said second user interface area further comprises:
facilitating retrieval of said each application component from said application server;
facilitating visual sequential analysis and removal of errors from said each application component.

24. The computer readable medium according to claim 19, wherein presenting said second user interface area further comprises:
facilitating selection of a debugging destination file to save debug session information associated with said debug session; and
facilitating storage of said debug session information in said debugging destination file.

25. The computer readable medium according to claim 20, wherein said starting component is a Java Server Page (JSP) view component.

26. The computer readable medium according to claim 20, wherein said starting component is an action component.

27. The computer readable medium according to claim 23, wherein said method further comprises:
facilitating retrieval of a process component of said application; and
presenting a third user interface area to facilitate analysis and removal of errors from said process component.

28. A system to facilitate visual analysis and removal of errors from an application to provide data to a user, said system comprising:
an application editor to present a first user interface area to display an application layout of said application, said application layout comprising a plurality of application icons and at least one connection that connects said plurality of application icons, each application icon corresponding to an application component of said application, and further to present a second user interface area to enable said user to execute said application and to run a debug session in order to visually remove said errors from each application component of said application displayed within said first user interface area.

29. The system according to claim 28, wherein said application editor further:
facilitates selection of an application server, which stores said application, from a server menu displayed within said second user interface area;
facilitates selection of said application from an application menu displayed within said second user interface area; and
facilitates selection of a starting component of said application from a component menu displayed within said second user interface area.

30. The system according to claim 28, wherein said application editor further facilitates loading of a browser in a browser window area to execute said application.

31. The system according to claim 30, wherein said browser displays in said browser window area a page defined by said application server, said application, and said starting component.

32. The system according to claim 29, wherein said application editor further:
facilitates retrieval of said each application component from said application server; and
facilitates visual sequential analysis and removal of errors from said each application component.

33. The system according to claim 28, wherein said application editor further:
facilitates selection of a debugging destination file to save debug session information associated with said debug session; and
facilitates storage of said debug session information in said debugging destination file.

34. The system according to claim 29, wherein said starting component is a Java Server Page (JSP) view component.

35. The system according to claim 29, wherein said starting component is an action component.

36. The system according to claim 32, further comprising:
a process editor coupled to said application editor to facilitate retrieval of a process component of said application, and to present a third user interface area to facilitate analysis and removal of errors from said process component.
